(19) United States
(12) Patent Application Publication
(10) Pub. No.: US 2018/0068317 A1
(43) Pub. Date: Mar. 8, 2018

(54) APPARATUS, SYSTEM, SERVER AND METHODS FOR CARRYING OUT A TRANSACTION

(71) Applicant: MasterCard Asia/Pacific Pte Ltd, Singapore (SG)

(72) Inventors: Benjamin Charles Gilbey, Singapore (SG); Vijin Venugopalan, Singapore (SG); Krishnadas Mohandas, Singapore (SG)

(21) Appl. No.: 15/692,235

(22) Filed: Aug. 31, 2017

(30) Foreign Application Priority Data
Sep. 7, 2016 (SG) 10201607450X

(51) Int. Cl. G06Q 20/40; G06F 21/32; H04M 7/00; H04W 12/06

(52) U.S. Cl. CPC G06Q 20/40145; G06F 21/32; H04M 2203/6045; H04W 12/06; H04M 7/0078

(57) ABSTRACT

There is provided an apparatus, system, server and method for carrying out a transaction. The apparatus, system, server and method enables positive authentication of a user, so that the transaction can be carried out.

### CROSS-REFERENCE TO RELATED APPLICATION

This application is a U.S. National Stage filing under 35 U.S.C. § 119, based on and claiming benefit of and priority to SG Patent Application No. 10201607450X filed Sep. 7, 2016.

### FIELD OF INVENTION

Embodiments of the present invention relate to various aspects of carrying out a transaction.

### BACKGROUND

Currently, intelligent assistants integrated into smartphones and other mobile devices are becoming increasingly common. Examples include Siri, Cortana, Google Now, Alexa and so forth. The ability of these intelligent assistants to enhance the convenience of users is getting better.

One of the reasons for the enhancement of convenience is because of the capability of the intelligent assistants to interface with software on the smartphones and other mobile devices. In some instances, the intelligent assistants become the sole interface between the user and the mobile device.

However, the voice-activated interface of the intelligent assistants currently do not distinguish amongst users providing the vocal instructions, and this leads to a situation of failure to identify the user providing the vocal instructions. This constrains the type of software that the intelligent assistants can interface with and also the types of tasks which the intelligent assistants can carry out.

### SUMMARY

In a first aspect, there is provided an apparatus configured for carrying out a transaction. The apparatus comprises a microphone for generating voice data based on a user input; and a processor to extract, from the voice data, one or more transaction instructions, and to authenticate the user based on the voice data. It is preferable that positive authentication of the user enables the carrying out of the one or more transaction instructions.

The apparatus can further comprise a digital wallet component to facilitate the transaction.

It is preferable that extracting the one or more transaction instructions include using a speech to text conversion to assess at least one parameter selected from a group of parameters such as, for example, identity of merchant, type of goods, type of services, time of delivery, keywords of the transaction instructions and so forth. The keywords can be predefined words for either carrying out particular transactional tasks or providing particular transaction-related information.

Preferably, the authentication of the user's voice data is carried out by assessment of at least one portion of the user input.

The processor can preferably be configured to authenticate the user based on the voice data by communicating with a voice biometric authentication server.

There is also provided a data processor implemented method for carrying out a transaction, the method comprising: receiving, via a microphone, voice data from a user; extracting, from the voice data, using a processor, one or more transaction instructions; authenticating, using the processor, the user based on the voice data; and receiving, at the processor, an authentication result of the user's voice data. It is preferable that positive authentication of the user enables the carrying out of the one or more transaction instructions. Alternatively, there is provided another data processor implemented method for carrying out a transaction, the method comprising: receiving, via a microphone, voice data from a user; extracting, from the voice data, using a processor, one or more transaction instructions; transmitting, to a voice biometric authentication server, the voice data; authenticating, at the voice biometric authentication server, the user based on the voice data; and receiving, at the processor, an authentication result of the user's voice data.

Preferably, positive authentication of the user enables the carrying out of the one or more transaction instructions.

The method can further comprise transmitting, to a digital wallet component, instructions to facilitate the transaction.

Preferably, extracting the one or more transaction instructions include using speech to text conversion to assess at least one parameter selected from a group of parameters such as, for example, identity of merchant, type of goods, type of services, time of delivery, keywords of the transaction instructions and so forth. The keywords can be predefined words for either carrying out particular transactional tasks or providing particular transaction-related information.

It is preferable that the authentication of the user's voice data is carried out by assessment of at least one portion of the user input.

There is also provided a non-transitory computer readable storage medium embodying thereon a program of computer readable instructions which, when executed by one or more processors of a user device, cause the user device to perform a method for carrying out a transaction. The method embodies the steps of: receiving, via a microphone, voice data from a user; extracting, from the voice data, using a processor, one or more transaction instructions; authenticating, using the processor, the user based on the voice data; and receiving, at the processor, an authentication result of the user's voice data. It is preferable that positive authentication of the user enables the carrying out of the one or more transaction instructions. Alternatively, the method embodies the steps of: receiving, via a microphone, voice data from a user; extracting, from the voice data, using a processor, one or more transaction instructions; transmitting, to a voice biometric authentication server, the voice data; authenticating, at the voice biometric authentication server, the user based on the voice data; and receiving, at the processor, an authentication result of the user's voice data. Preferably, positive authentication of the user enables the carrying out of the one or more transaction instructions.

The methods can further embody the step: transmitting, to a digital wallet component, instructions to facilitate the transaction.

It is preferable that extracting the one or more transaction instructions include using speech to text conversion to assess at least one parameter selected from a group of parameters consisting of, for example, identity of merchant, type of goods, type of services, time of delivery, keywords of the purchase instructions and the like. The keywords can be predefined words for either carrying out particular transactional tasks or providing particular transaction-related information.

It is preferable that the authentication of the user's voice data is carried out by assessment of at least one portion of the user input.

In a further aspect, there is provided a server configured for carrying out a transaction, the server being configured to carry out a method comprising:

receiving, from a user device, a user's voice data; authenticating, at a processor, the user based on the voice data; and transmitting, to the user device, an authentication result of the user's voice data. Preferably, positive authentication of the user enables the carrying out of one or more transaction instructions. It is preferable that the authentication of the user's voice data is carried out by assessment of at least one portion of the user's voice data.

In addition, there is also provided a non-transitory computer readable storage medium embodying thereon a program of computer readable instructions which, when executed by one or more processors of a server in communication with at least one user device, cause the server to perform a method for carrying out a transaction. The method embodies the steps of: receiving, from the at least one user device, a user's voice data; authenticating, at a processor, the user based on the voice data; and transmitting, to the user device, an authentication result of the user's voice data. It is preferable that positive authentication of the user enables the carrying out of one or more transaction instructions. Preferably, the authentication of the user's voice data is carried out by assessment of at least one portion of the user's voice data.

In a final aspect, there is provided a system configured for carrying out a transaction, the system including one or more electronic processing devices that: generates voice data based on a user input; extracts one or more transaction instructions; and authenticates the user based on the voice data. It is preferable that positive authentication of the user enables the carrying out of the one or more transaction instructions. Furthermore, the system can further include one or more electronic processing devices that facilitates the transaction using a digital wallet component.

### DESCRIPTION OF FIGURES

In order that the present invention may be fully understood and readily put into practical effect, there shall now be described by way of non-limitative example only, certain embodiments of the present invention, the description being with reference to the accompanying illustrative figures, in which:

FIG. 1 shows a schematic view of a user device according to certain embodiments of the present invention.

FIG. 2 shows a schematic view of a server according to certain embodiments of the present invention.

FIG. 3 shows an overview of a system according to certain embodiments of the present invention.

FIG. 4 shows a process flow of a data processor implemented method on a user device according to certain embodiments of the present invention.

FIG. 5 shows a process flow of a data processor implemented method on a server according to certain embodiments of the present invention.

### DETAILED DESCRIPTION

There is provided an apparatus, system, server and methods for carrying out a transaction. In at least some embodiments, the apparatus, system, server and methods allow users to carry out transactions using voice commands, where the voice providing the commands are biometrically authenticated prior to or simultaneously with the carrying out of the transactions. Being able to carry out transactions in such a manner may reduce the load on telecommunication networks and/or servers used to carry out the transactions, since the same voice data which is used for biometric authentication is also used for processing the user's transaction request. Furthermore, it is convenient for users.

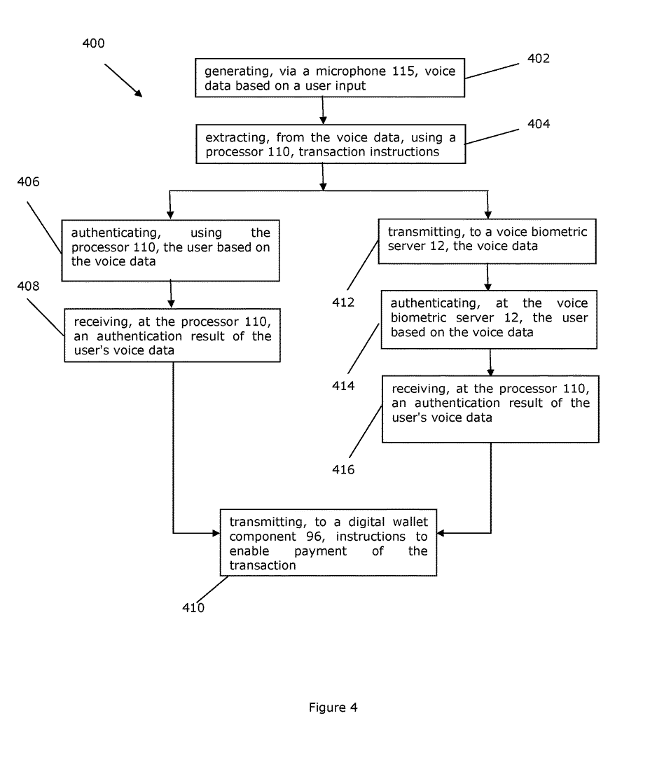

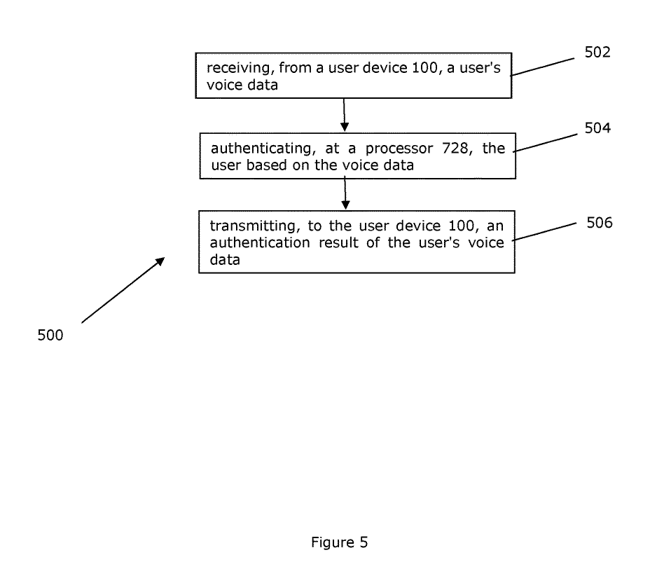

FIGS. 4 and 5 show steps of respective methods 400, 500 of embodiments of the present invention. The methods 400, 500 are depicted in a flow diagram, where each of the blocks of the flow diagram may be executed by a data processor(s) or a portion of the data processor (for example, a single core of a multi-core processor). The processes may be embodied in a non-transient machine-readable and/or computer-readable medium for configuring a computer system to execute the methods. A software module(s) may be stored within and/or transmitted to a computer system memory to configure the computer system to carry out the tasks indicated in each of the blocks of the respective flow diagrams.

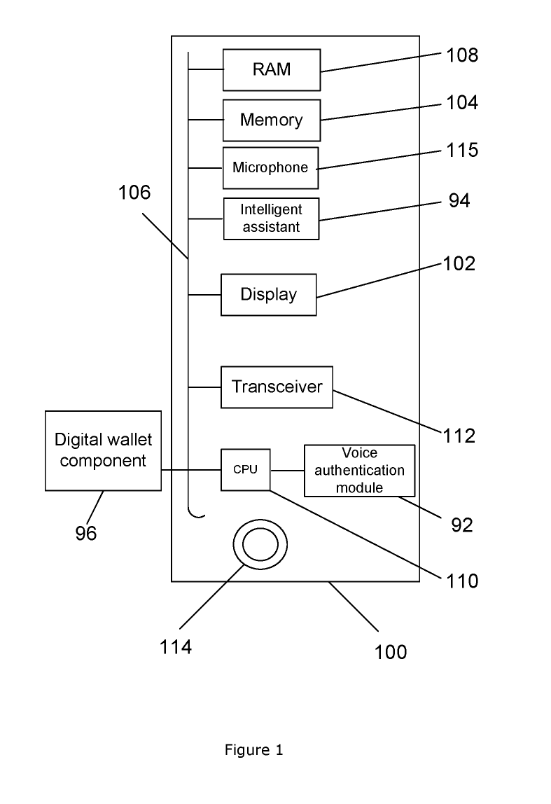

Referring to FIG. 1, there is shown a mobile device 100 which can be configured to carry out a transaction. The mobile device 100 is a handheld device such as a smartphone or a tablet computer such as one manufactured by Apple™, LG™, HTC™, Samsung™, and Motorola™. As shown, the device 100 includes the following components in electronic communication via a bus 106:

a display 102;

non-volatile memory 104;

random access memory (“RAM”) 108;

N processing components 110;

a microphone 115;

a transceiver component 112 that includes N transceivers; and

user controls 114.

Although the components depicted in FIG. 1 represent physical components, FIG. 1 is not intended to be a hardware diagram; thus many of the components depicted in FIG. 1 may be realized by common constructs or distributed among additional physical components. Moreover, it is certainly contemplated that other existing and yet-to-be developed physical components and architectures may be utilized to implement the functional components described with reference to FIG. 1.

The display 102 generally operates to provide a presentation of content to a user, and may be realized by any of a variety of displays (e.g., CRT, LCD, HDMI, micro-projector and OLED displays). And in general, the non-volatile memory 104 functions to store (e.g. persistently store) data and executable code including code that is associated with the functional components of the method. In some embodiments, for example, the non-volatile memory 104 includes bootloader code, modem software, operating system code, file system code, and code to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The microphone 115 is for receiving a user's verbal instructions, which can include instructions for carrying out the transaction. The processing components 110 can be configured to determine a nature of the transaction, and in parallel, to either communicate with a voice biometric authentication server (via the transceiver 112) to authenticate the user's voice data providing the verbal transaction instructions, or to perform such authentication on the device 100 itself. There can be a voice authentication module 92 for performing the authentication locally on the device 100.

Determining the nature of the transaction can include assessing, using, for example, a known speech to text conversion methodology before determining text of the verbal instructions, at least one parameter such as, for example, identity of merchant, type of goods, type of services, time of delivery, keywords of the transaction instructions and so forth. The keywords can be predefined words for either carrying out particular tasks or providing particular information, such as, for example, “buy”, “purchase”, “transfer”, “deliver to”, “pre-order”, “confirm”, “gift to”, “expedite delivery” and so forth. It should be appreciated that the user can be interfacing with an intelligent assistant 94 integrated with the mobile device 100 when providing the verbal transaction instructions. This is possible due to the ability of the intelligent assistant 94 to interface with software applications installed/running on the mobile device 100.

In addition, the mobile device 100 can further comprise a digital wallet component 96 to facilitate the transaction. The digital wallet component 96 can be a software application that is installed on the mobile device 100. Alternatively, the digital wallet component 96 can be a digital wallet service provider that is accessible using the mobile device 100. The digital wallet component 96 can be accessed either remotely by the mobile device 100 or locally on the mobile device 100. Typically, the digital wallet component 96 generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard). The merchant system then submits an authorization request to, for example, a payment service provider (PSP), a digital wallet service provider or the merchant's acquirer in known manner. It is appreciated that suitable known methods of conducting secure electronic commerce transactions can be employed.

The mobile device 100 can be configured in a manner where positive authentication of the user's voice data enables the carrying out of the transaction. Authentication of the user's voice data can be carried out in a manner which involves steps such as, for example, enrolment of the user's voice print/template (stored on device 100 or in external storage/cloud), where the voice print is generated from raw speech data; generation of the voice signal for comparative analysis with the template, where the comparative analysis is carried out on the device 100 or in external storage/cloud; speech to text conversion which can be carried out simultaneously or separately from the authentication process; and the like.

It should be noted that positive authentication can take place when a match of the user's voice data with the user's voice print/template within a pre-determined threshold occurs. Any suitable matching algorithm may be used for the voice data authentication process.

The authentication of the user's voice data can be carried out by assessment of at least one portion of the user's voice data providing the verbal transaction instructions. It should be appreciated that the positive authentication of the user's voice is to confirm the identity of the user such that the user is authorised to carry out a desired transaction.

Referring to FIG. 4, there is provided a process flow of a data processor implemented method 400 for carrying out a transaction. The method 400 can be one of the ways employed by the mobile device 100 to carry out a transaction. For the sake of illustration, components referred to in the method 400 are in relation to mobile device 100, but the method 400 should not be construed to be applicable only to the mobile device 100.

The method 400 comprises generating, via a microphone 115, voice data based on a user input (402). It should be appreciated that prior to providing the input, the user may be interfacing with an intelligent assistant integrated with the mobile device 100 when providing the input. This is possible due to the ability of the intelligent assistant to interface with software applications installed/running on the mobile device 100.

Subsequently, there is extracting, from the voice data using a processor 110, one or more transaction instructions (404). Determining the nature of the transaction includes assessing at least one parameter such as, for example, identity of merchant, type of goods, type of services, time of delivery, and keywords of the purchase instructions. The keywords are predefined words for either carrying out particular tasks or providing particular information, such as, for example, “buy”, “purchase”, “transfer”, “deliver to”, “pre-order”, “confirm”, “gift to”, “expedite delivery”, “home”, “from” and so forth.

In the method 400, it is possible to carry out authentication either on the mobile device 100 or an external voice biometric server 12.

When the authentication is carried out on the mobile device 100, there is authentication of the user based on the voice data, using the processor 110 (406). The authentication result is then received at the processor 110 (408).

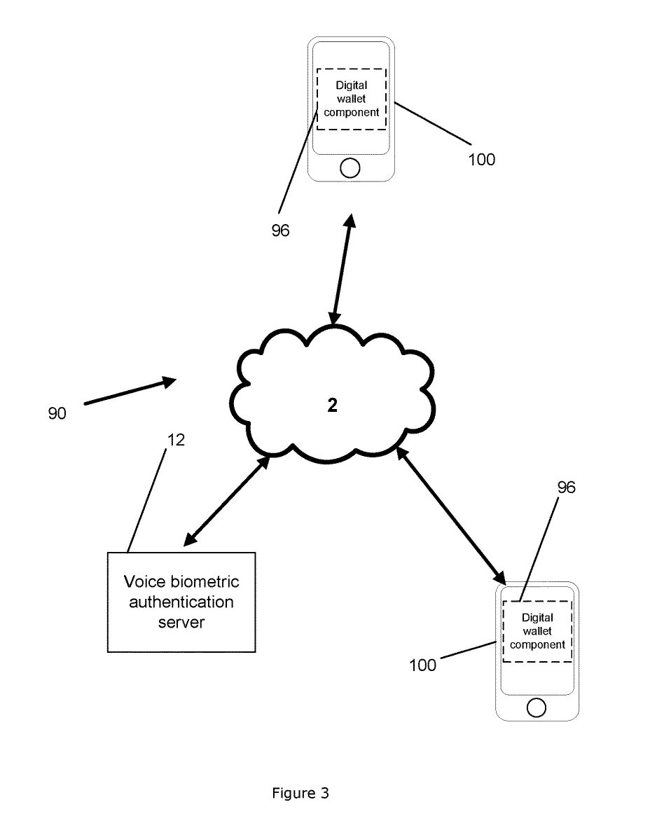

When the authentication is carried out on the voice biometric server 12, there is transmitting, to a voice biometric authentication server 12 (shown in FIG. 3), the user's voice data (412). The authentication of the user's voice data at the voice biometric authentication server 12 can be carried out by assessment of at least one portion of the user's voice data (414). It should be appreciated that positive authentication of the user is to confirm the identity of the user such that the user is authorised to carry out a desired transaction(s).

Subsequently, there is receiving, at the processor 110, an authentication result of the user's voice data (416).

Under all circumstances, if there is a positive authentication result of the user to enable the carrying out of one or more transaction instructions, there is transmitting, to a digital wallet component 96, instructions to enable payment of the desired transaction (410).

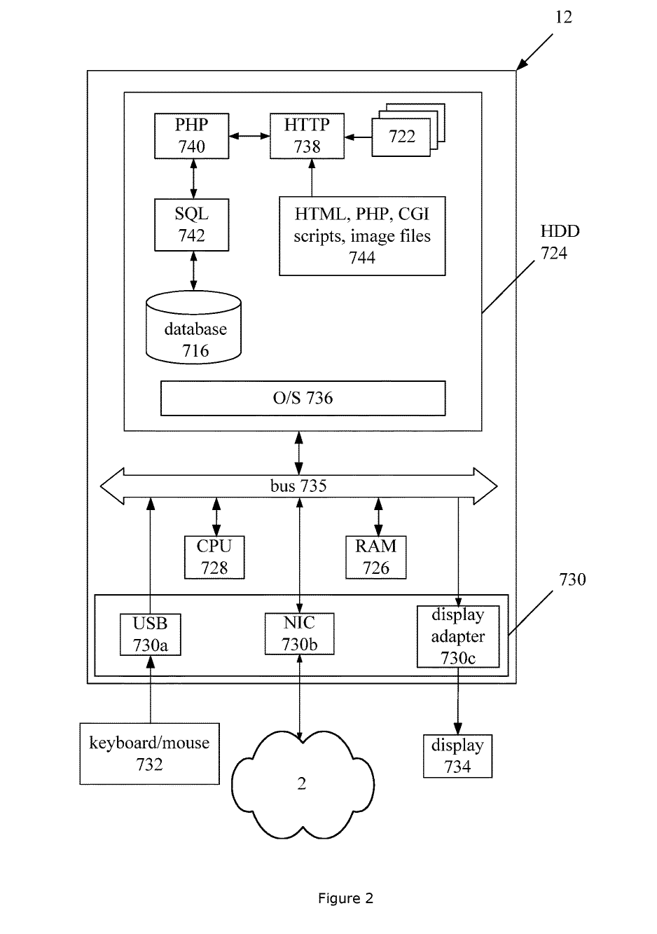

Referring to FIG. 2, there is shown an example of a voice authentication server 12 which is a commercially available server computer system based on a 32 bit or a 64 bit Intel architecture. The processes and/or methods executed or performed by the server 12 are implemented in the form of programming instructions of one or more software components or modules 722 stored on non-volatile (e.g., hard disk) computer-readable storage 724 associated with the server 12. At least parts of the software modules 722 could alternatively be implemented as one or more dedicated hardware components, such as application-specific integrated circuits (ASICs) and/or field programmable gate arrays (FPGAs).

The server 12 includes at least one or more of the following standard, commercially available, computer components, all interconnected by a bus 735:
1. random access memory (RAM) 726;
2. at least one computer processor 728, and
3. external computer interfaces 730:
a. universal serial bus (USB) interfaces 730a (at least one of which is connected to one or more user-interface devices, such as a keyboard, a pointing device (e.g., a mouse 732 or touchpad),
b. a network interface connector (NIC) 730b which connects the server 12 to a data communications network, such as the Internet 2; and
c. a display adapter 730c, which is connected to a display device 734 such as a liquid-crystal display (LCD) panel device.

The server 12 includes a plurality of standard software modules, including:
1. an operating system (OS) 736 (e.g., Linux or Microsoft Windows);
2. web server software 738 (e.g., Apache, available at http://www.apache.org);
3. scripting language modules 740 (e.g., personal home page or PHP, available at http://www.php.net, or Microsoft ASP); and
4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 12 with the general ability to allow users of the mobile device 100 equipped with appropriate software to access the server 12 and in particular to provide data to and receive data from the database 716 resultant of the authentication process. The server 12 is able to communicate with the mobile device 100 over a communications network 2 using standard communication protocols. It will be understood by those skilled in the art that the specific functionality provided by the server 12 to such users is provided by scripts accessible by the web server 738, including the one or more software modules 722 implementing the processes performed by the server 12, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 12 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 12 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

It should be appreciated that the method 50 can be configured to be performed in a variety of ways. The steps can be implemented entirely by software to be executed on standard computer server hardware, which may comprise one hardware unit or different computer hardware units distributed over various locations, some of which may require the communications network 2 for communication. A number of the components or parts thereof may also be implemented by application specific integrated circuits (ASICs) or field programmable gate arrays.

Referring to FIG. 5, there is shown a server 12 that is configured for carrying out a transaction, the server 12 being configured to carry out a method 500 comprising receiving, from a user device 100, a user's voice data (502). The method 500 includes authenticating, at the processor 728, the user based on the voice data (504). The authentication of the user's voice data can be carried out by assessing at least one portion of the voice data. It should be noted that the database 716 of the server 12 is configured to store voice templates/prints of users to enable the authentication of the voice data received from the user by the server 12. It should be noted that the authentication of the user's voice can also be carried out on the user device 100.

The method 500 also includes transmitting, to the user device 100, an authentication result of the user's voice data (506), whereby a positive authentication of the user enables the carrying out of the one or more transaction instructions. It should be appreciated that the positive authentication of the user is to confirm the identity of the user such that the user is authorised to carry out desired transaction(s).

With reference to FIG. 3, there is also provided a system 90 configured for carrying out a transaction. The system 90 comprises at least one user device 100 for receiving a user's voice data; and a voice biometric authentication server 12 configured for authenticating the user's voice data. The at least one user device 100 and the server 12 can be communicatively coupled over a communications network 2, and the methods 400, 500 can be carried out within the system 90. In the system 90, a positive authentication of the user's voice data enables the carrying out of one or more transaction instructions, whereby the positive authentication of the user is to confirm the identity of the user.

It should be noted that the apparatus 100, server 90 and methods 400, 500 can operate together to carry out one or more transaction instructions for a user, whereby the user is able to simply utilise voice commands to carry out the desired transaction while possibly interfacing with an intelligent assistant on the user's mobile device 100. Some examples of voice commands and corresponding objectives of the user can include:

“order food from XXX to home” for delivering food from XXX to the user's home;

“pre-order book from YYY for gift to me” for pre-ordering a book from YYY for the user;

“transfer money to account XYX” for transferring money from the digital wallet 96 to an account designated by the user; and

“buy groceries from AAA to home” for ordering groceries to the user's home.

It should be appreciated that the user is able to enjoy substantial conveniences, and save some time and effort to carry out some desired tasks. This is because the user does not need to access specific software applications to carry out desired transactions, or does not need to make telephone calls to carry out desired transactions.

Whilst there have been described in the foregoing description preferred embodiments of the present invention, it will be understood by those skilled in the technology concerned that many variations or modifications in details of design or construction may be made without departing from the present invention.

1. An apparatus configured for carrying out a transaction, the apparatus corn prising:
a microphone for generating voice data based on a user input; and
a processor to extract, from the voice data, one or more transaction instructions, and to authenticate the user based on the voice data;
wherein positive authentication of the user enables the carrying out of the one or more transaction instructions.

2. The apparatus of claim 1, further comprising a digital wallet component to facilitate the transaction.

3. The apparatus of claim 1, wherein extracting the one or more transaction instructions include using a speech to text conversion to assess at least one parameter selected from a group of parameters consisting of: identity of merchant, type of goods, type of services, time of delivery, and keywords of the transaction instructions, and wherein the keywords are predefined words for either carrying out particular transactional tasks or providing particular transaction-related information.

4. The apparatus of claim 1, wherein the authentication of the user's voice data is carried out by assessment of at least one portion of the user input.

5. The apparatus of claim 1, wherein the processor is configured to authenticate the user based on the voice data by communicating with a voice biometric authentication server.

6. A data processor implemented method for carrying out a transaction, the method comprising:
receiving, via a microphone, voice data from a user;
extracting, from the voice data, using a processor, one or more transaction instructions;
authenticating, using the processor, the user based on the voice data; and
receiving, at the processor, an authentication result of the user's voice data;
wherein positive authentication of the user enables the carrying out of the one or more transaction instructions.

7. The method of claim 6, further comprising:
transmitting, to a digital wallet component, instructions to facilitate the transaction.

8. The method of claim 6, wherein extracting the one or more transaction instructions include using speech to text conversion to assess at least one parameter selected from a group of parameters consisting of: identity of merchant, type of goods, type of services, time of delivery, and keywords of the transaction instructions, and wherein the keywords are predefined words for either carrying out particular transactional tasks or providing particular transaction-related information.

9. The method of claim 6, wherein the authentication of the user's voice data is carried out by assessment of at least one portion of the user input.

10. A non-transitory computer readable storage medium embodying thereon a program of computer readable instructions which, when executed by one or more processors of a user device, cause the user device to perform a method for carrying out a transaction, the method embodying the steps of:
receiving, via a microphone, voice data from a user;
extracting, from the voice data, using a processor, one or more transaction instructions;
authenticating, using the processor, the user based on the voice data; and
receiving, at the processor, an authentication result of the user's voice data;
wherein positive authentication of the user enables the carrying out of the one or more transaction instructions.

11. A non-transitory computer readable storage medium embodying thereon a program of computer readable instructions which, when executed by one or more processors of a user device, cause the user device to perform a method for carrying out a transaction, the method embodying the steps of:
receiving, via a microphone, voice data from a user;
extracting, from the voice data, using a processor, one or more transaction instructions;
transmitting, to a voice biometric authentication server, the voice data;
authenticating, at the voice biometric authentication server, the user based on the voice data; and
receiving, at the processor, an authentication result of the user's voice data;
wherein positive authentication of the user enables the carrying out of the one or more transaction instructions.

12. The storage medium of claim 11, the method further embodying the step:
transmitting, to a digital wallet component, instructions to facilitate the transaction.

13. The storage medium of claim 11, wherein extracting the one or more transaction instructions include using speech to text conversion to assess at least one parameter selected from a group of parameters consisting of: identity of merchant, type of goods, type of services, time of delivery, and keywords of the purchase instructions, and wherein the keywords are predefined words for either carrying out particular transactional tasks or providing particular transaction-related information.

14. The storage medium of claim 11, wherein the authentication of the user's voice data is carried out by assessment of at least one portion of the user input.

15. A server configured for carrying out a transaction, the server being configured to carry out a method comprising:
receiving, from a user device, a user's voice data;
authenticating, at a processor, the user based on the voice data; and
transmitting, to the user device, an authentication result of the user's voice data,
wherein positive authentication of the user enables the carrying out of one or more transaction instructions.

16. The server of claim 15, wherein the authentication of the user's voice data is carried out by assessment of at least one portion of the user's voice data.

17. A system configured for carrying out a transaction, the system including one or more electronic processing devices that:
generates voice data based on a user input;
extracts one or more transaction instructions; and
authenticates the user based on the voice data;
wherein positive authentication of the user enables the carrying out of the one or more transaction instructions.

18. The system of claim 17, further including one or more electronic processing devices that:
facilitates the transaction using a digital wallet component.
